(19) United States
(12) Patent Application Publication
(10) Pub. No.: US 2008/0217310 A1
(43) Pub. Date: Sep. 11, 2008

(54) METHOD FOR PROFILING THE PERIMETER BORDER OF A SEMICONDUCTOR WAFER

(76) Inventor: Harald Fischer, Osterronfeld (DE)

Correspondence Address: VIDAS, ARRETT & STEINKRAUS, P.A., SUITE 400, 6640 SHADY OAK ROAD, EDEN PRAIRIE, MN, 55344, US

(21) Appl. No.: 11/758,362

(22) Filed: Jun. 5, 2007

(30) Foreign Application Priority Data
Mar. 9, 2007 (DE) 10 2007 011 513.1

(51) Int. Cl. B23K 26/02

(52) U.S. Cl. 219/121.68; 219/121.6; 219/121.75; 219/121.78; 219/121.82; 219/121.84

(57) ABSTRACT

A method for profiling the perimeter border of a semiconductor chip, characterized by the following steps: the semiconductor chip is supported near to the perimeter border on supporting points which are spaced apart in the perimeter direction of the semiconductor chip, laser beams are directed to the perimeter border with the aid of at least two lasers or of two lens systems coupled with at least one laser, which are arranged on the perimeter of the laser chip, the lasers or lens systems and the semiconductor chip are rotated in relation to each other around the centre of the semiconductor chip, and the lasers or lens systems are moved in a plane vertical to the rotational plane such that portions of the perimeter border between the supporting points are profiled by laser irradiation, subsequently, the supporting points on the semiconductor chip are changed and the remaining border portions of the perimeter border are profiled, and during profiling, the hitting point of the laser beams on the perimeter border is cooled with a fluid.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

The present invention is related to a method for profiling the perimeter border of a semiconductor chip.

In electronics, microelectronics and micro-electromechanics, semiconductor chips are used as starting materials (substrates). There are extremely high requirements with respect to the global and local evenness, roughness, cleanness and freeness from impurity atoms and so on. The plane processing takes place by grinding and polishing in a so-called double side machine, as is described in DE 103 44 602 A1, the entire contents of which is incorporated herein by reference, or even DE 10 2004 040 429, the entire contents of which is incorporated herein by reference, for example. After the plane processing, profiling of the perimeter border takes place, wherein it is important before others to reshape the sharp edges of the perimeter border correspondingly, such that tweaking out of the material in the edge region can be avoided. The edge processing can take place by grinding or polishing. It has also already become known to perform profiling of the perimeter border of semiconductor chips with the aid of a laser processing.

The present invention is related to the profiling of the perimeter border of a semiconductor chip, and the present invention is based on the objective to provide a method for this, by which a desired profile can be formed in a processing time as short as possible. By the method which is aimed at, the usable area of the semiconductor chip is to be reduced only to a minimal degree.

### BRIEF SUMMARY OF THE INVENTION

The method according to the present invention is composed of plural following steps: The semiconductor chip is supported near to the perimeter border on supporting points which are spaced apart in the perimeter direction of the semiconductor chip. The supporting should occupy as little area of the semiconductor chip as possible, because each mechanical contact of the very precisely processed plane is unwanted. With the aid of at least two lasers or of two lens systems coupled with at least one laser, which are arranged on the perimeter of the laser chip, laser beams are directed to the perimeter border. With two lasers or lens systems, the same are arranged at 180° angle distance. When there is spoken from lens systems here, this means the coupling of a light wave guide to a laser, on the other end of which one or several lenses are arranged, the focal point of which is on the perimeter border of the semiconductor chip to be processed. Usually, even the laser is equipped with a lens, the focal point of which is situated on the perimeter border of the semiconductor chip.

The lasers or lens systems and the semiconductor chip are rotated in relation to each other around the centre of the semiconductor chip, and the lasers or lens systems are moved in a plane vertical to the rotational plane, such that portions of the perimeter border between the supporting points are profiled by laser irradiation. It is to be understood that with the aid of such a procedure, only the portions between the supporting points are processed, whereas the portions in the region of the supporting points are processed only after the semiconductor chip has changed its angular position with respect to the support.

It is to be understood that between semiconductor chip on the one hand and laser or lens systems on the other hand, not only a relative movement has to be performed, but instead a movement vertical to the rotational plane must also occur, which takes place via the laser or lens systems for the most, in order to have created a desired profile on the perimeter border across its cross section. Further, it is to be understood that there can be provided even more than two lasers or lens systems, which are spaced apart in the perimeter direction. Further, it is conceivable to provide two or more lasers or lens systems at a time for the upper and lower edge of the border of a semiconductor chip, through which the movement vertical to the rotational axis can be made a little bit smaller.

In the method according to the present invention, cooling of the hitting point of the laser beams takes also place, so that a thermal change of the texture of the material of the semiconductor chip is avoided,

With the aid of the method according to the present invention, rapid edge processing with freely definable shape of the perimeter border is possible. The processing of the perimeter border can be adapted to the procedure sequence in the production process of a semiconductor chip, and can be optimized for better area utilization. The throughput times can be improved, through which even the cost per part of the semiconductor chip is reduced.

According to one embodiment of the present invention, the relative rotation and the movement of the lasers or lens systems vertical to the rotational plane of the semiconductor chip are performed simultaneously or successively. In a relatively slow motion, of the lasers or lens systems for instance, the complete profile can be simultaneously obtained with a corresponding movement of the laser beams vertical to the rotational plane. By suitably setting the angle of the laser beam with respect to the edge, a movement in relation to the rotational plane during the edge processing of the laser or the lens system, respectively, may be perhaps avoided.

According to a further embodiment of the present invention, a detecting device is assigned to the lasers or lens systems, which detects the unprocessed border portions after the change of the support of the semiconductor chip about a certain angle of rotation. The described process can take place completely automatically. After the perimeter border portions situated between the supporting points have been profiled, the semiconductor chip is rotated in relation to the supporting points with the aid of a practical device. Thereafter, the unprocessed portions are detected with the aid of the detecting device and subsequently they are profiled in the same way as the previously mentioned border portions.

When profiling the perimeter border portions of the semiconductor chip, the latter is preferably stationary, whereas the lasers or lens systems are moved.

In order to cool down the hitting points of the laser beam, a fluid jet is directed towards the focal point of the laser beam.

An apparatus for performing the method according to the present invention is distinguished by the following features:

A device for supporting the semiconductor chip on supporting points which are spaced apart in the perimeter direction near to the border of the semiconductor chip is provided. At least two lasers or lens systems, which are coupled to at least one laser, are arranged at the perimeter of the semiconductor chip on the supporting points. A rotation device, which rotates the lasers or lens systems and the semiconductor chip in relation to each other around the centre of the semiconductor chip, provides for the movement of a laser beam along a perimeter border of the semiconductor chip in order to profile the same. Further, rotation means are provided, by which the semiconductor chip can be rotated in relation to the supporting points. According to one embodiment of the present invention, the rotation means have lifting means for lifting the semiconductor chip above the supporting points. Further, they are formed such that they rotate the semiconductor chip above the supporting points about a predetermined angle. For instance, this takes place with the aid of a water jet stream.

Further, the apparatus according to the present invention has adjustment means for adjusting the lasers or lens systems in a plane vertical to the rotational plane of the semiconductor chip on the supporting points. With the aid of the adjustment means, a movement of the lasers or lens systems in relation to the border of the semiconductor chip can take place, in order to set the necessary processing angle between laser beam and perimeter border of the semiconductor chip. Finally, the apparatus according to the present invention provides a cooling device for cooling the respective hitting point of the laser beams on the semiconductor chip. A control unit serves for the co-ordination of the individual operations, of the rotation device, the rotation means, the adjustment means and the cooling device in particular.

When using lens systems, one single laser can be provided, which is connected with the lens systems via a multiple coupling and via light wave guides.

For the application of a cooling fluid, spray nozzles can be provided, which are formed such that the laser beam is guided through their centre.

### BRIEF DESCRIPTION OF THE SEVERAL VIEWS OF THE DRAWINGS

The present invention is to be explained in more detail by means of drawings in the following.

FIG. 1 shows a section through a part of the semiconductor chip before the perimeter border is profiled.

FIG. 2 shows the section through the semiconductor chip according to FIG. 1 after the perimeter border is profiled

FIG. 3 shows the top view on a very schematically represented apparatus for profiling the perimeter border of a semiconductor chip.

FIG. 4 schematically shows the possibilities of adjustment of a laser source for profiling the perimeter border of a semiconductor chip.

FIG. 5 shows a representation similar to that of FIG. 3 with a different apparatus for producing the laser beams.

FIG. 6 shows schematically a spray nozzle with light wave guide.

FIG. 7 shows schematically the possibilities of movement of the components according to FIG. 3.

FIG. 8 shows schematically two possibilities of movement of a wafer.

FIG. 9 shows an outline of the control of the apparatus according to FIG. 3 or according to FIG. 7.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated.

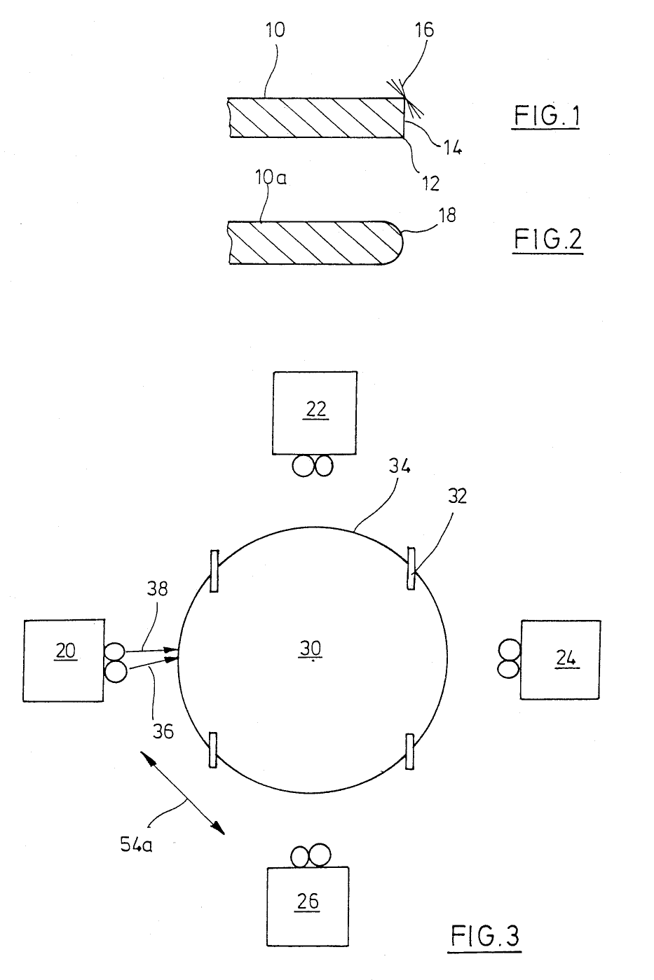

A semiconductor chip 10 in FIG. 1 is to be regarded as a flat cylinder, with relatively sharp edges 12 of its perimeter border 14. When processing of the edges 12 is performed along the lines 16, a desired profile can be imparted to the perimeter border 14. Such a profile can be recognized at 18 of the semiconductor chip 10a in FIG. 2. The apparatuses according to FIG. 3 and 5 are suited for producing such a profile.

In FIG. 3, four laser units 20, 22, 24, 26 are arranged at an angle distance of 90° around a semiconductor chip 30. The semiconductor chip 30 is supported on four supporting points 32, which touch the lower surface of the semiconductor chip 30 only in the border region. With respect to the laser units 20 to 26, the supporting points 32 are situated between neighboring laser units each one at a time. For the rest, the distance of the laser units 20 to 26 from the perimeter border 34 of the semiconductor chip 30 is equal.

Each laser unit 20 to 26 contains a laser, with the aid of which a laser beam 36 can be directed towards the perimeter border 34. In addition, each laser unit 20 to 26 has a cooling device, with the aid of which a cooling fluid jet 38 is directed towards the hitting location of the laser beam 36. The realization of a cooling of the hitting location of the laser beam is possible through an apparatus according to FIG. 6, for instance. In FIG. 6 a spray nozzle 40 is shown, into which a fluid is introduced from a suitable cooling source, a deionized water, for instance. A light wave guide 42 is arranged coaxially to the axis of the nozzle 40, via which a laser beam emerges.

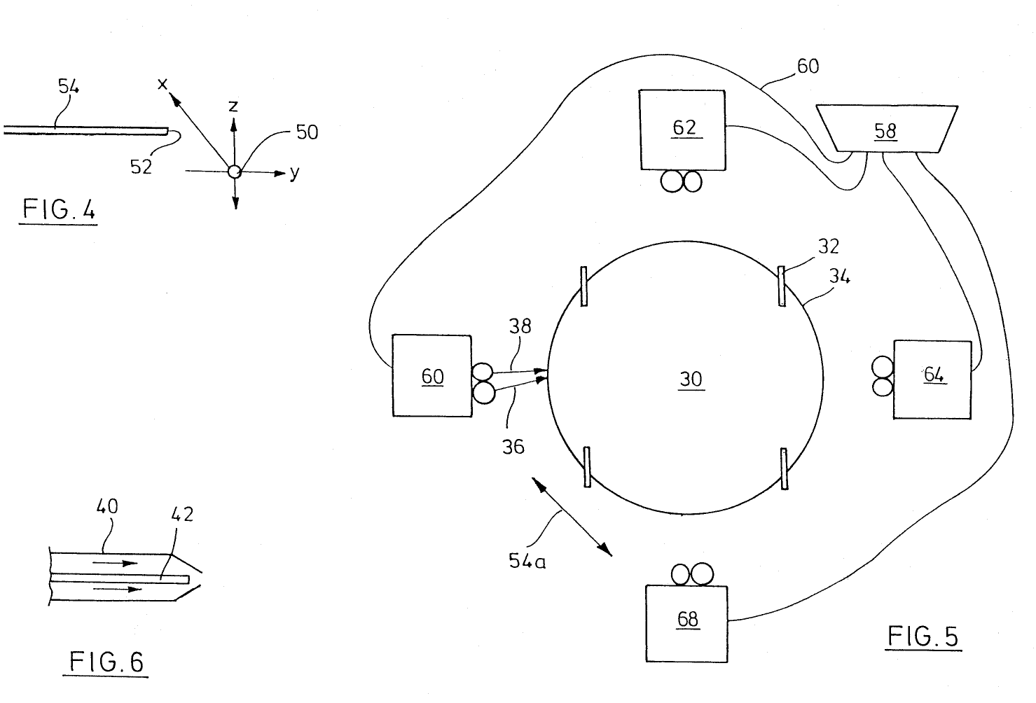

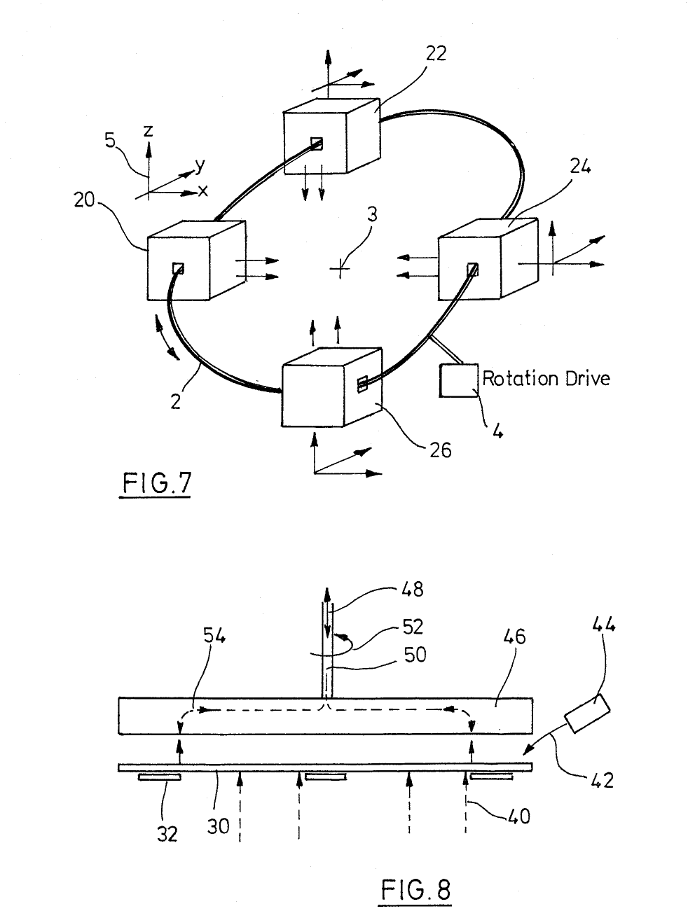

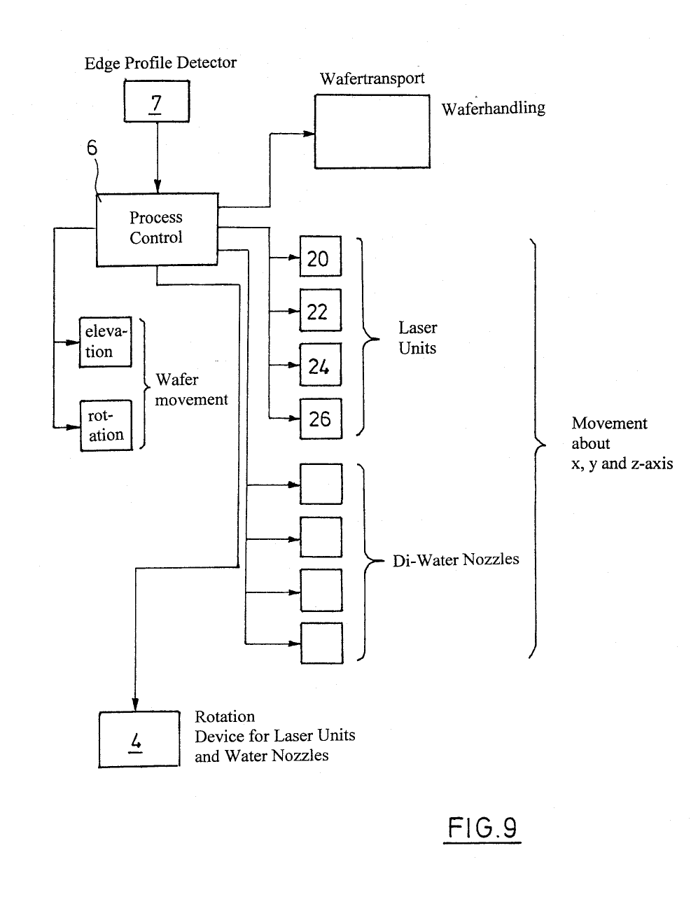

In FIG. 4, a laser unit is indicated at 50, which can direct a laser beam towards a perimeter edge on the perimeter border 52 of a semiconductor chip 54. The laser 50 can be adjusted through its drawn in three axes X, Y and Z. The same is also valid for the laser units 20 to 26 according to FIG. 3. In addition, by the arrow 54a in FIG. 3, it is to be indicated that the laser units 20 to 26 are coupled with a common rotating unit (not shown), in order to move the laser units 20 to 26 concentrically to the perimeter border 34 of the semiconductor chip 30. In FIG. 7, it is shown how the units 20 to 24 are coupled with a ring arrangement 2, which is rotatably mounted around an axis 3 and which can be rotated by a drive motor 4. This takes place for profiling the border portions of the perimeter border 34 between respective neighboring supporting points 32. In order to be able to profile the complete border 34, a movement of the laser beam 36 in a plane situated vertical to the rotational plane of the laser units 20 to 26, vertical to the drawings plane in this case, is necessary in addition. The semiconductor chip 30 remains stationary. The possibilities for movement of the units 20 to 24 are indicated by the x, y and z-axis at 5 in FIG. 7.

The embodiment according to FIG. 5 differs from that one according to FIG. 3 in that one central laser 58 is provided, which is connected via light wave guides 60 with four processing units 60, 62, 64 and 68. The processing units 60 to 68 correspond to the laser units 20 to 26 with respect to their arrangement and movement possibilities. From the same, a laser beam 36 is directed via corresponding lens systems onto the perimeter border of the semiconductor chip 30 on the supporting points 32, as well as a cooling fluid jet 38, as has been described in connection with FIG. 3. Even the adjustment axes of the processing units 60 to 68 correspond to those according to FIG. 4.

As has been already mentioned, an edge profiling can take place only between the supporting points 32. When the corresponding border portions are profiled, the semiconductor chip 30 is somewhat lifted with the aid of suitable means, with the aid of a vacuum for instance, and at the same time, it is rotated about a certain amount with respect to the supporting points 32, so that the border portions not processed up to now are exposed and can now be processed in an additional processing step by the laser units 20 to 26 or the processing units 60 to 68, respectively.

The described process is controlled by a suitable control unit 6. A detecting device 7 belongs to the same also, which after rotating the semiconductor chip 30 with respect to the supporting points 32 detects those border portions which had not been profiled up to then. Subsequently, profiling of these border portions takes place.

In FIG. 8, the wafer 30 on the supporting points 32 is represented in a side view. With the aid of air, as is indicated through arrows 40, the wafer 30 can be lifted up somewhat from the supports 32. With the aid of a water jet stream 42, which is directed from a nozzle 44 from the upside skew onto the lifted wafer 32, the wafer can be rotated about a certain angle. Subsequently, it is let down again on the supporting points 32.

Alternatively, a disc 46 is represented in FIG. 8, which can be lifted up and lowered down, respectively, by a not shown apparatus, as is indicated by the double arrow 48. In addition, a shaft 50 of the disc can be rotated, as is indicated by arrow 52. In addition, the disc has suction openings on its lower side (not shown). Via the shaft 50, a vacuum can be applied on the suction openings, as is indicated by the arrows 54. When the disc 46 is lowered down on the wafer, the wafer is connected with the disc 46, provided that a corresponding suction force is applied. Subsequently, the disc with the wafer 30 can be lifted somewhat and subsequently it can be rotated. Thereafter, the wafer is lowered down again on the supporting points 32.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A method for profiling the perimeter border of a semiconductor chip, characterized by the following steps: the semiconductor chip is supported near to the perimeter border on supporting points which are spaced apart in the perimeter direction of the semiconductor chip, laser beams are directed to the perimeter border with the aid of at least two lasers or of two lens systems coupled with at least one laser, which are arranged on the perimeter of the laser chip, the lasers or lens systems and the semiconductor chip are rotated in relation to each other around the centre of the semiconductor chip, and the lasers or lens systems are moved in a plane vertical to the rotational plane such that portions of the perimeter border between the supporting points are profiled by laser irradiation, subsequently, the supporting points on the semiconductor chip are changed and the remaining border portions of the perimeter border are profiled, and during profiling, the hitting point of the laser beams on the perimeter border is cooled with a fluid.

2. A method according to point 1, characterized in that the relative rotation and the movement of the lasers or lens systems vertical to the rotational plane of the semiconductor chip are performed simultaneously or successively.

3. A method according to claim 1, characterized in that a detecting device is assigned to the lasers or lens systems, which detects the unprocessed border portions after the change of the supporting positions on the semiconductor chip through the relative rotation of semiconductor chip and laser or lens systems.

4. A method according to claim 1, characterized in that the semiconductor chip is stationary in the profiling of the perimeter border.

5. A method according to claim 1, characterized in that a fluid jet is directed on the focal point of the laser beam.

6. An apparatus for profiling the perimeter border of a semiconductor chip, with the following features: a device for supporting the semiconductor chip (30) on supporting points (32) which are spaced apart in the perimeter direction near to the border (34) of the semiconductor chip (30), at least two lasers or lens systems (20 to 26 or 60 to 68, respectively) coupled to at least one laser, at the perimeter of the semiconductor chip (30) on the supporting points (32), a rotation device, which rotates the lasers or lens systems (20 to 26 or 60 to 68, respectively) and the semiconductor chip (30) in relation to each other around the centre of the semiconductor chip (30), rotation means for rotating the semiconductor chip (30) in relation to the supporting points (32) adjustment means for adjusting the lasers or lens systems in a plane vertical to the rotational plane of the semiconductor chip (30) on the supporting points (32), a cooling device for cooling the hitting points of the laser beams on the semiconductor chip (30), and a control unit for the rotation device, the rotation means, the adjustment means and the cooling device.

7. An apparatus according to claim 6, characterized in that the supporting device holds the semiconductor chip (30) stationary.

8. An apparatus according to claim 6, characterized in that when using lens systems, one single laser (58) is provided, which is connected with the lens systems (60 to 68) via a multiple coupling and with the aid of light wave guides (60).

9. An apparatus according to claim 1, characterized in that spray nozzles (40) for a cooling fluid are provided, through the centre of which the laser beam is guided.

10. An apparatus according to claim 1, characterized in that the adjustment means for the lasers or lens systems are adjustable along three orthogonal axes X, Y, Z.

11. An apparatus according to a claim 1, characterized in that a detecting device is provided for the detection of unprofiled portions of the perimeter border (34) of the semiconductor chip (30) and that output signals of the detecting device are given up to the control unit.

12. An apparatus according to claim 1, characterized in that the rotation means have lifting means for lifting the semiconductor chip (30) above the supporting points (32) and are further formed such that they rotate the semiconductor chip (30) above the supporting points (32) about a predetermined angle.
